(19) United States
(12) Patent Application Publication
(10) Pub. No.: US 2024/0319483 A1
(43) Pub. Date: Sep. 26, 2024

(54) VOLUME HOLOGRAPHIC OPTICAL ELEMENT PROJECTION SYSTEM

(71) Applicant: National Central University, Taoyuan City (TW)

(72) Inventors: Wen-Hsin SUN, Taoyuan City (TW); Wei-Chia SU, Changhua County (TW); Jun-Yi YU, Tainan City (TW); Ching-Cherng SUN, Taoyuan City (TW)

(21) Appl. No.: 18/365,203

(22) Filed: Aug. 3, 2023

(30) Foreign Application Priority Data
Mar. 24, 2023 (TW) 112111289

(51) Int. Cl. G02B 13/16; G02B 5/32; G02B 27/01

(52) U.S. Cl. CPC G02B 13/16; G02B 5/32; G02B 27/0172; G02B 2027/0107; G02B 2027/0174

(57) ABSTRACT

A volume holographic optical element projection system includes a projection lens, a polarizing beam splitter, a liquid crystal on silicon panel, and a volume holographic optical element. The projection lens includes a light incident side, a light emitting side, and nine lenses. A f-number of the projection lens is in a range from 1 to 3. The f-number is a value derived from dividing the focal length by the entrance pupil diameter. The liquid crystal on silicon panel includes a protection glass. The polarizing beam splitter is located between the light incident side of the projection lens and the protection glass of the liquid crystal on silicon panel. The light emitting side of the projection lens faces the volume holographic optical element.

### CROSS-REFERENCE TO RELATED APPLICATION

This application claims priority to Taiwan Application Serial Number 112111289, filed Mar. 24, 2023, which is herein incorporated by reference in its entirety.

### BACKGROUND

### Field of Invention

The present invention relates to a volume holographic optical element projection system.

### Description of Related Art

As the electrical technology progresses, more head-mounted display device having three-dimensional visual ability are produced. The head-mounted display devices include virtual reality, augmented reality and mixed reality fields. Applications of the volume holographic optical element in those fields have profound development potential.

However, current product has the disadvantages such as poor light usage efficiency and optical system minimization difficulties. Accordingly, it is still a development direction for the industry to enhance light efficiency, minimize optical system, and improve optical quality in such devices.

### SUMMARY

The invention provides a volume holographic optical element projection system.

In one embodiment, the volume holographic optical element projection system includes a projection lens, a polarizing beam splitter, a liquid crystal on silicon panel, and a volume holographic optical element. The projection lens includes a light incident side, a light emitting side, and nine lenses. An f-number of the projection lens is in a range from 1 to 3. The f-number is a value derived from dividing the focal length by the entrance pupil diameter. The liquid crystal on silicon panel includes a protection glass. The polarizing beam splitter is located between the light incident side of the projection lens and the protection glass of the liquid crystal on silicon panel. The light emitting side of the projection lens faces the volume holographic optical element.

Another aspect of the present disclosure is a volume holographic optical element projection system.

In one embodiment, the volume holographic optical element projection system includes a projection lens, an aperture, a polarizing beam splitter, a liquid crystal on silicon panel, and a volume holographic optical element. The projection lens includes a light incident side, a light emitting side, and nine lenses. An f-number of the projection lens is in a range from 1 to 3. The f-number is a value derived from dividing the focal length by the entrance pupil diameter. The aperture is located adjacent to the light emitting side, and a diameter of the aperture is substantially equal to the entrance pupil diameter of the projection lens. The liquid crystal on silicon panel includes a protection glass. The polarizing beam splitter is located between the light incident side of the projection lens and the protection glass of the liquid crystal on silicon panel. The light emitting side of the projection lens faces the volume holographic optical element.

In the aforesaid embodiments, the f-number of the projection lens of the present disclosure is in a range from 1 to 3. Therefore, the projection lens applied in a projection system having a volume holographic optical element can enhance efficiency of the light entering the volume holographic optical element. The aperture of the projection lens is disposed at the surface of the first lens close to the light emitting side so as to avoid missing of image boundary.

### BRIEF DESCRIPTION OF THE DRAWINGS

The invention can be more fully understood by reading the following detailed description of the embodiment, with reference made to the accompanying drawings as follows:

FIG. 1 is a schematic of a volume holographic optical element projection system according to one embodiment of the present disclosure.

FIG. 2 is the projection lens, the polarizing beam splitter, and the protection glass in FIG. 1.

FIG. 3 is an optical path figure of the projection lens, the polarizing beam splitter, and the projection glass in FIG. 2.

FIG. 4 is specifications of the projection lens, the polarizing beam splitter, and the protection glass in FIG. 2.

FIG. 5 is the third-order aberrations based on the projection lens, the polarizing beam splitter, and the protection glass in FIG. 3.

FIG. 6 is astigmatism field curvature based on the projection lens, the polarizing beam splitter, and the protection glass in FIG. 3.

FIG. 7 is a distortion diagram based on the projection lens, the polarizing beam splitter, and the protection glass in FIG. 3.

FIG. 8 and FIG. 9 are Modulation Transfer Function diagrams based on the projection lens, the polarizing beam splitter, and the protection glass in FIG. 3.

FIG. 10 is a table of the impact of the polarizing beam splitter and the protection glass of the liquid crystal on silicon panel on the third-order aberrations.

FIG. 11 is a graph of the impact of the polarizing beam splitter and the protection glass of the liquid crystal on silicon panel on the Modulation Transfer Function.

FIG. 12 is a graph of the relative illumination based on the projection lens, the polarizing beam splitter, and the protection glass in FIG. 3.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

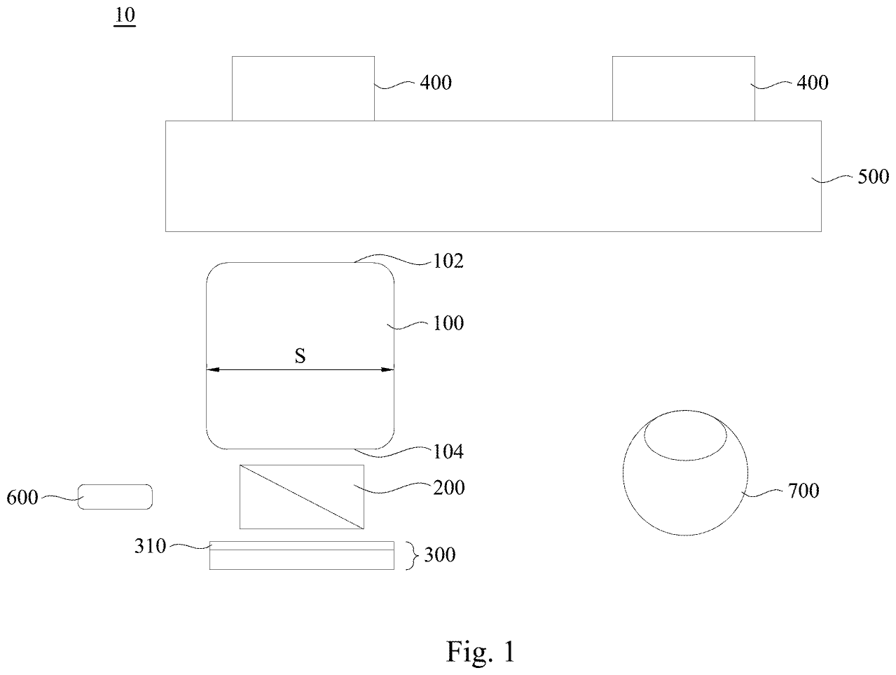

FIG. 1 is a schematic of a volume holographic optical element projection system 10 according to one embodiment of the present disclosure. The volume holographic optical element projection system 10 includes a projection lens 100, a polarizing beam splitter 200, a liquid crystal on silicon panel 300, a volume holographic optical element 400, a light guide element 500, and a light source 600.

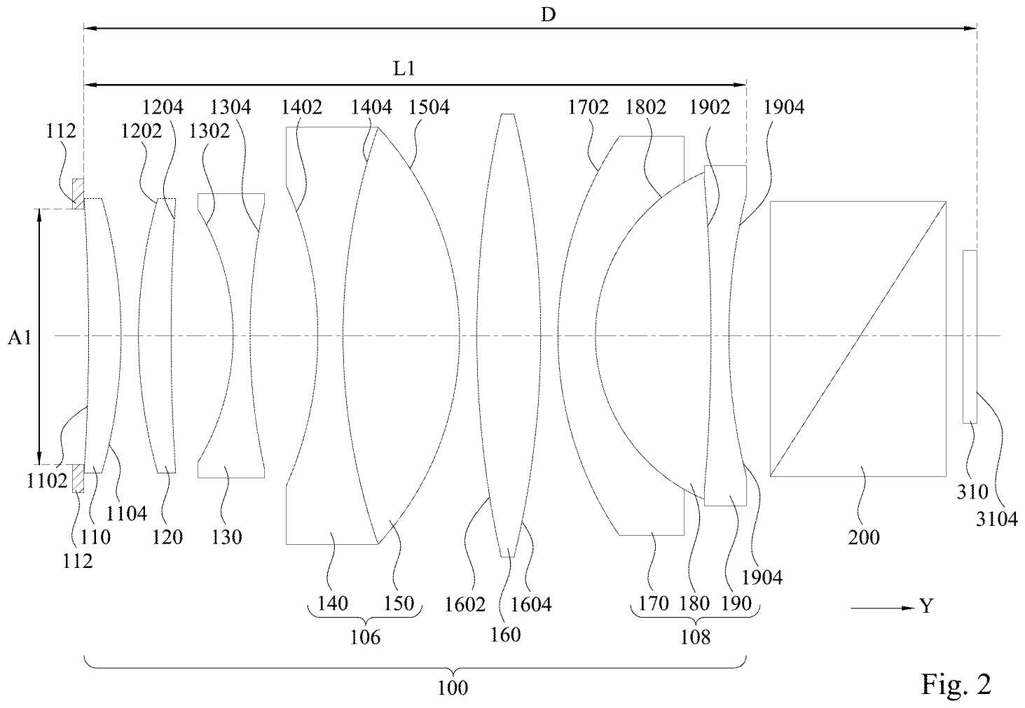

FIG. 2 is the projection lens 100, the polarizing beam splitter 200, and the protection glass 310 in FIG. 1. Reference is made to FIG. 1 and FIG. 2. The projection lens 100 includes a light emitting side 102, a light incident side 104, and nine lenses. The f-number of the projection lens 100 is in a range from 1 to 3. The f-number is a value derived from dividing the focal length of the projection lens 100 by the entrance pupil diameter (EPD). In a proper embodiment, the f-number of the projection lens 100 is 1.1745. An effective focal length of the projection lens 100 is about 16.4430 mm. The entrance pupil diameter of the projection lens 100 is 13.9997 mm.

The liquid crystal on silicon panel 300 includes a protection glass 310. The polarizing beam splitter 200 is located between the light incident side 104 of the projection lens 100 and the protection glass 310 of the liquid crystal on silicon panel 300. The light emitting side 102 of the projection lens 100 faces the volume holographic optical element 400.

Reference is made to FIG. 1. The volume holographic optical element projection system 10 is a head-mounted display device. For example, the volume holographic optical element projection system 10 can be a Mixed Reality display. The size of the housing of the projection lens 100 is smaller than 30 mm, which is beneficial for applications in head-mounted display devices.

The light emitted from the light source 600 passes through the polarizing beam splitter 200 and is guided towards the liquid crystal on silicon panel 300. An image generated by the liquid crystal on silicon panel 300 enters the light guide element 500 after passing through the liquid crystal on silicon panel 300 and the projection lens 100. The light entered the light guide element 500 is guided to the observation region 700 through the volume holographic optical element 400. The projection lens 100 can enhance efficiency of the light entering the volume holographic optical element 400 to assure that the light from the liquid crystal on silicon panel 300 is effectively entered into the volume holographic optical element 400. The configurations of the light guide element 500 and the volume holographic optical element 400 demonstrated herein are examples, which can be changed by the person having ordinary skill in the art depends on the practical requirements.

Reference is made to FIG. 1 and FIG. 2. Nine lens of the projection lens 100 includes a first lens 110, a second lens 120, a third lens 130, a fourth lens 140, a fifth lens 150, a sixth lens 160, a seventh lens 170, an eighth lens 180, and a ninth lens 190 respectively presented from the light emitting side 102 to the light incident side 104.

The projection lens 100 further includes an aperture 112 at a surface 1102 of the first lens 110 facing the light emitting side 102. A diameter A1 of the aperture 112 is in a range of 13.5 mm to 14.5 mm. The aperture 112 is proximate to the surface 1102 of the first lens 110 or directly contacts the surface 1102 of the first lens 110. By such design, the diameter A1 of the aperture 112 of the projection lens 100 substantially equals the entrance pupil diameter so as to avoid missing of image boundary.

A total length L1 of the projection lens 100 is in a range from 38 mm to 39 mm, and a distance D between the surface 1102 of the first lens 110 and a surface 3104 of the protection glass 310 is in a range from 50 mm to 51 mm. As such, it is beneficial for head-mounted display devices. The total length L1 is a distance between the surface 1102 of the first lens 110 and the surface 1904 of the ninth lens 190. The surface 3104 of the protection glass 310 is an imaging plane. For example, the total length L1 of the present embodiment is about 38.791 mm, and the distance D of the present embodiment is about 50.4912 mm.

The fourth lens 140 and the fifth lens 150 are glued to form a first lens group 106 by UV glue. The seventh lens 170, the eighth lens 180, and the ninth lens 190 are glued to form a second lens group 108 by UV glue. With such design, it can reduce dispersion of the projection lens 100.

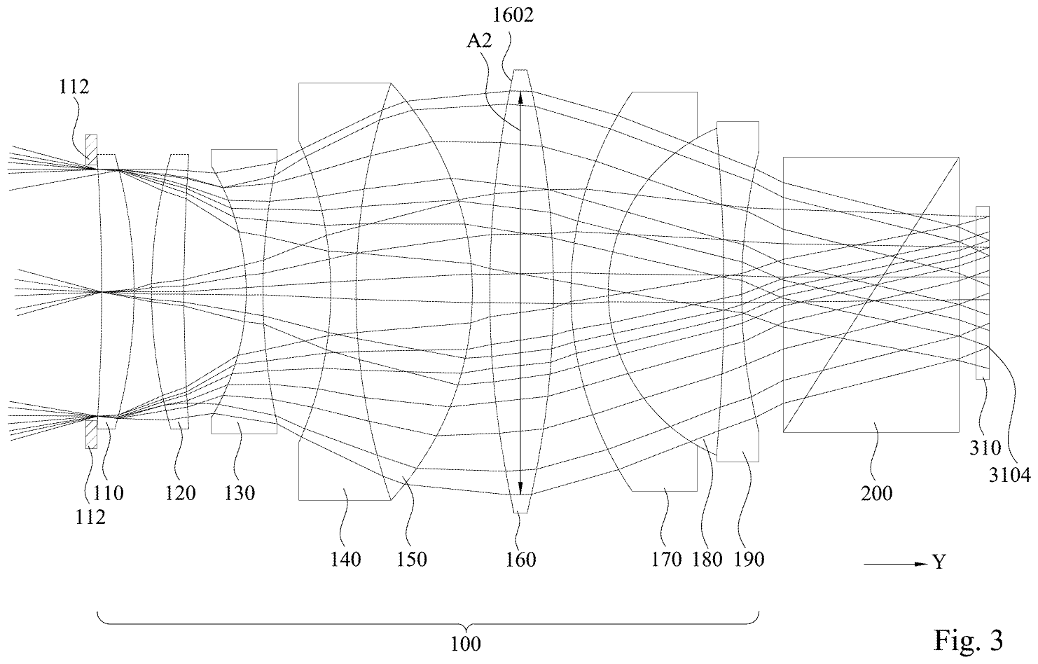

FIG. 3 is an optical path figure of the projection lens 100, the polarizing beam splitter 200, and the protection glass 310 in FIG. 2. A field of view of the projection lens 100 is greater than 25 degrees and smaller than 35 degrees. In the following description, a center filed is defined as 0 degree and an edge field is defined as 15 degrees (half field of view, HFOV). A maximum effective diameter of the ninth lenses is smaller than or equal to 23 mm. As shown in FIG. 2, the effective diameter A2 is the maximum effective diameter of the sixth lens 160. The effective diameter A2 is about 23 mm and is located at a surface 1602 facing the light emitting side 102.

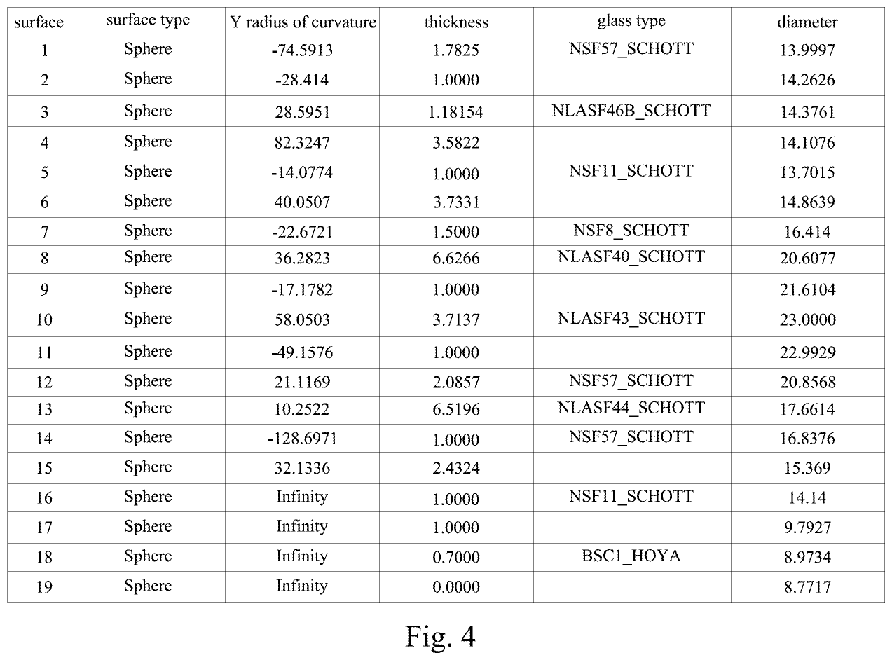

FIG. 4 is specifications of the projection lens 100, the polarizing beam splitter 200, and the protection glass 310 in FIG. 2. Reference is made to FIG. 2 and FIG. 4. Numbers in FIG. 4 represents surface type, radius of curvature, thickness from adjacent surfaces and glass type of each surface along the direction Y from the surface 1102 of the first lens 110 to the surface 3104 of the protection glass 310. In the present embodiment, the material of the nine lenses of the projection lens 100 is glass, and each of the nine lenses of the projection lens 100 is a spherical lens. With such design, the cost of the projection lens 100 can be reduced.

In other embodiments, the material of a part of the nine lenses is plastic, or the material of all nine lenses is plastic. In other embodiments, a part of the nine lenses is non-spherical lenses, or all nine lenses are non-spherical lenses.

The first lens 110 is a convex lens. Surfaces of number 1 and number 2 represents the surface 1102 and the surface 1104 of the first lens 110. The values of the radii of curvature of the surface 1102 and the surface 1104 along the direction Y are all negative.

The second lens 120 is a convex lens. Surfaces of number 3 and number 4 represents the surface 1202 and another surface 1204 of the second lens 120. The values of the radii of curvature of the surface 1202 and the surface 1204 along the direction Y are all positive.

The third lens 130 is a concave lens. Surfaces of number 5 and number 6 represents the surface 1302 and another surface 1304 of the third lens 130. The values of the radii of curvature of the surface 1302 and the surface 1304 along the direction Y are respectively negative and positive.

Surfaces of number 7 to number 9 respectively represents a surface 1402, a surface 1404, and a surface 1504 of the first lens group 106. The values of the radii of curvature of the surface 1402, the surface 1404, and the surface 1504 are respectively negative, positive, and negative.

The sixth lens 160 is a convex lens. Surfaces of number 10 and number 11 represents the surface 1602 and the surface 1604 of the sixth lens 160. The values of the radii of curvature of the surface 1602 and the surface 1604 along the direction Y are respectively positive and negative.

Surfaces of number 12 to number 15 respectively represents a surface 1702, a surface 1802, a surface 1902, and a surface 1904 of the second lens group 108. The values of the corresponding radii of curvatures are respectively positive, positive, negative, and positive.

Reference is made to FIG. 2 and FIG. 4. The radius of aperture of the surface 1102 is substantially the radius aperture A1 of the aperture 112. Reference is made to FIG. 3 and FIG. 4. The radii of aperture of the first lens 110, the second lens 120, and the third lens 130 are all smaller than 15 mm. The radii of aperture of the first lens group 106, the second lens group 108, and the sixth lens 160 are greater than 16 mm and are smaller than or equal to 23 mm. With such design, it is beneficial for applications in head-mounted display devices.

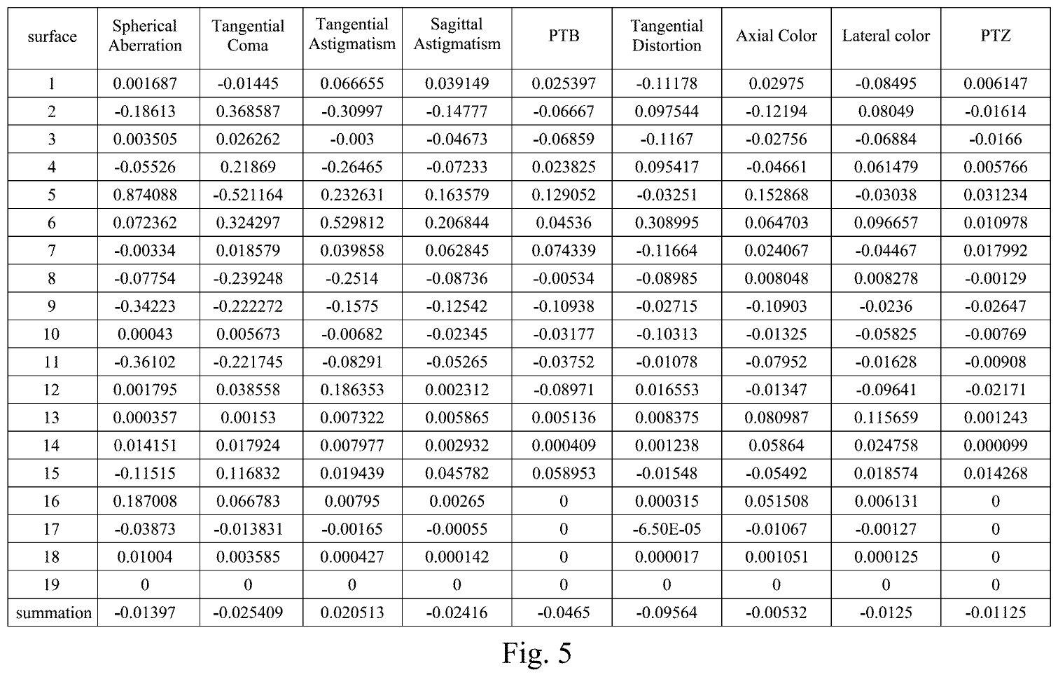

FIG. 5 is the third-order aberrations based on the projection lens 100, the polarizing beam splitter 200, and the protection glass 310 in FIG. 3. Spherical Aberration, Tangential Coma, Tangential Astigmatism, Sagittal Astigmatism, PTB, Tangential Distortion, Axial Color, Lateral color, and PTZ of each surface and summations of those third-order aberrations are listed in FIG. 5.

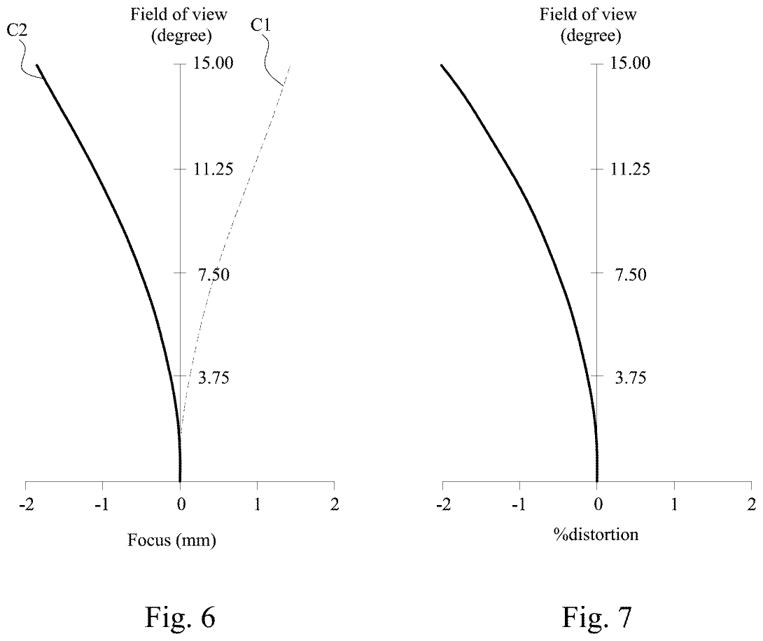

FIG. 6 is astigmatism field curvature based on the projection lens 100, the polarizing beam splitter 200, and the protection glass 310 in FIG. 3. The astigmatism field curvature of the projection lens 100 of the present disclosure is measured based on wavelengths of 656.273 nm, 587.562 nm, and 486.133 nm, respectively. Wavelength of 587.562 nm is used as an example in FIG. 6. Curve C1 and curve C2 represent tangential field curvature and sagittal field curvature, respectively. As shown in FIG. 6, the value of the field curvature from center field (field of view is 0 degree) to the edge field (field of view is 15 degrees) is in a range from −2 to +2.

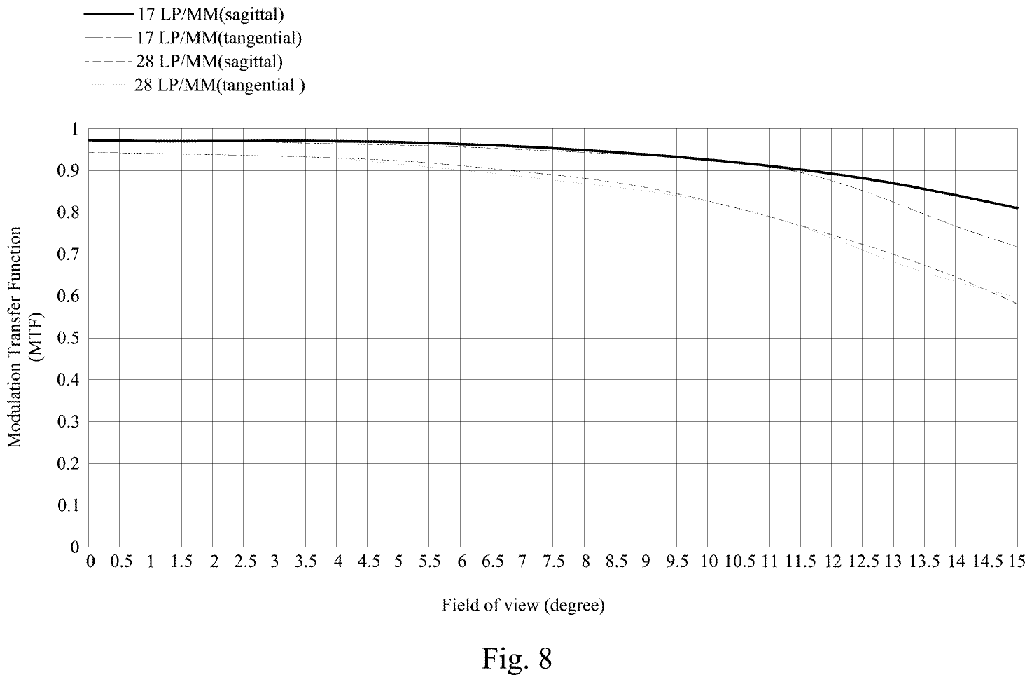

FIG. 7 is a distortion diagram based on the projection lens 100, the polarizing beam splitter 200, and the protection glass 310 in FIG. 3. As shown in FIG. 7, the distortion of the projection lens 100 from center field (field of view is 0 degree) to the edge field (field of view is 15 degrees) is within 2%.

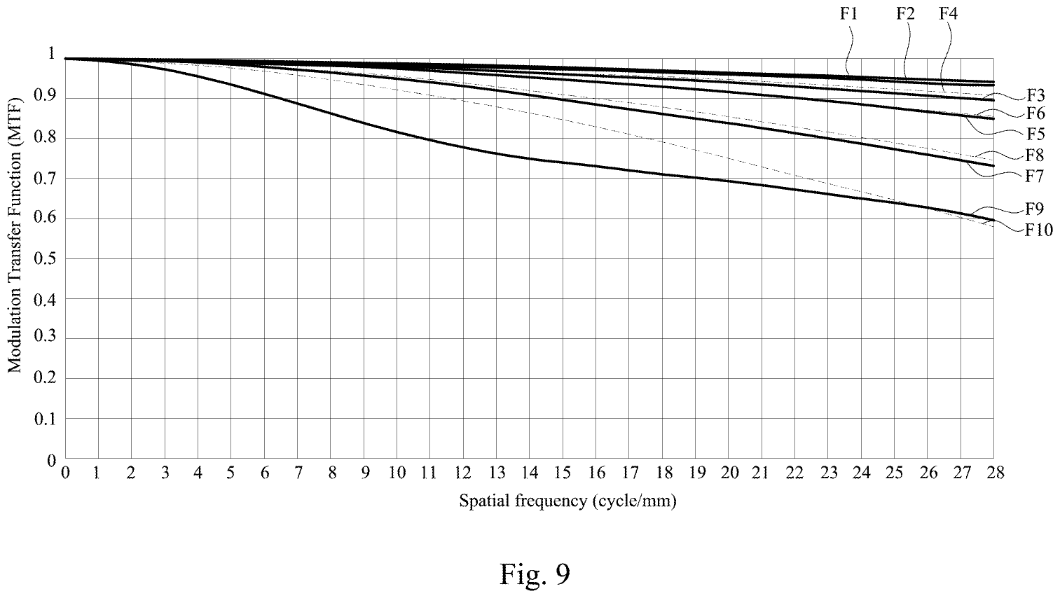

FIG. 8 and FIG. 9 are Modulation Transfer Function (MTF) diagrams based on the projection lens 100, the polarizing beam splitter 200, and the protection glass 310 in FIG. 3. The Modulation Transfer Function of the projection lens 100 are measured based on wavelengths of 656.273 nm, 587.562 nm, and 486.133 nm, respectively. Wavelength of 587.562 nm is used as an example in FIG. 8 and FIG. 9. Tangential MTF and sagittal MTF from the center field (0 degree) to the edge field (15 degrees) with spatial frequencies of 17 LP/MM and 28 LP/MM are illustrated in FIG. 8. Values of the aforementioned curves in FIG. 8 are all above 0.583. The curves of the tangential MTF and the sagittal MTF having spatial frequency of 17 LP/MM are close to each other, and the curves of the tangential MTF and the sagittal MTF having spatial frequency of 28 LP/MM are close to each other. Accordingly, the combination of the projection lens 100, the polarizing beam splitter 200, and the protection glass 310 of the present disclosure has great optical quality.

The curves F1˜F10 in FIG. 9 represents specific field of view, respectively. The tangential MTF and the sagittal MTF with different spatial frequencies are illustrated in FIG. 9. Curve F1 represents the MTF at 0 degree (center field). Curve F2 represents the tangential MTF and the sagittal MTF with field of view of 3 degrees. Curve F3 and Curve F4 represent the tangential MTF and the sagittal MTF with field of view of 6 degrees, respectively. Curve F5 and Curve F6 represent the tangential MTF and the sagittal MTF with field of view of 9 degrees, respectively. Curve F7 and Curve F8 represent the tangential MTF and the sagittal MTF with field of view of 12 degrees, respectively. Curve F9 and Curve F10 represent the tangential MTF and the sagittal MTF with field of view of 15 degrees, respectively.

Reference is made to FIG. 8 and FIG. 9. Curves of MTF under different field of view and different spatial frequencies are continuous and smooth curves. Accordingly, the combination of the projection lens 100, the polarizing beam splitter 200, and the protection glass 310 of the present disclosure has great optical quality within field of view of 30 degrees and spatial frequency of 28 LP/MM.

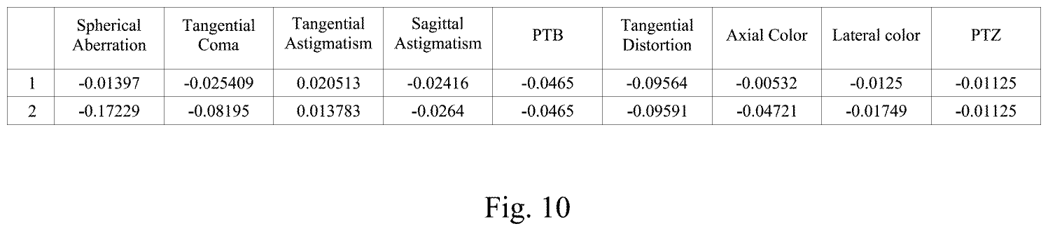

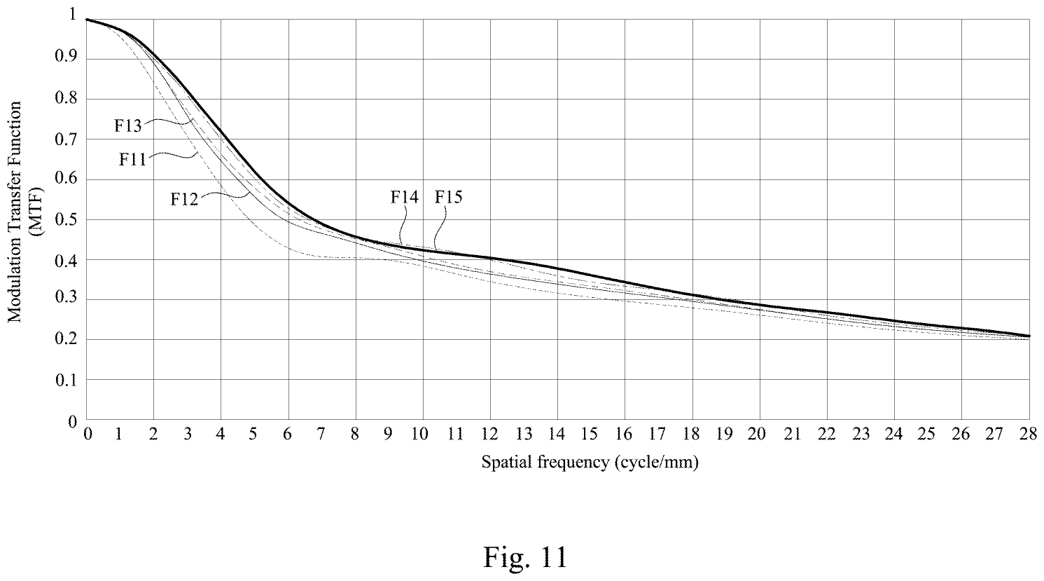

FIG. 10 is a table of the impact of the polarizing beam splitter 200 and the protection glass 310 of the liquid crystal on silicon panel 300 on the third-order aberrations. FIG. 11 is a graph of the impact of the polarizing beam splitter 200 and the protection glass 310 of the liquid crystal on silicon panel 300 on the Modulation Transfer Function. Data number 1 is the summation of the third-order aberrations of the projection lens 100, the polarizing beam splitter 200 and the liquid crystal on silicon panel 300 shown in FIG. 4. Data number 2 is summation of the third-order aberrations without the polarizing beam splitter 200 and the liquid crystal on silicon panel 300. Curves F11 to F15 shown in FIG. 11 respectively represent the Modulation Transfer Function without the polarizing beam splitter 200 and the liquid crystal on silicon panel 300. Tangential MTF at 0 degree, 7.5 degrees, 9 degrees, 13.5 degrees, and 15 degrees are illustrated as examples in FIG. 11. It can be seen from FIG. 9 to FIG. 11 that the combination of the polarizing beam splitter 200, the protection glass 310, and the projection lens 100 can effectively improve the third-order aberrations and enhance the Modulation Transfer Function.

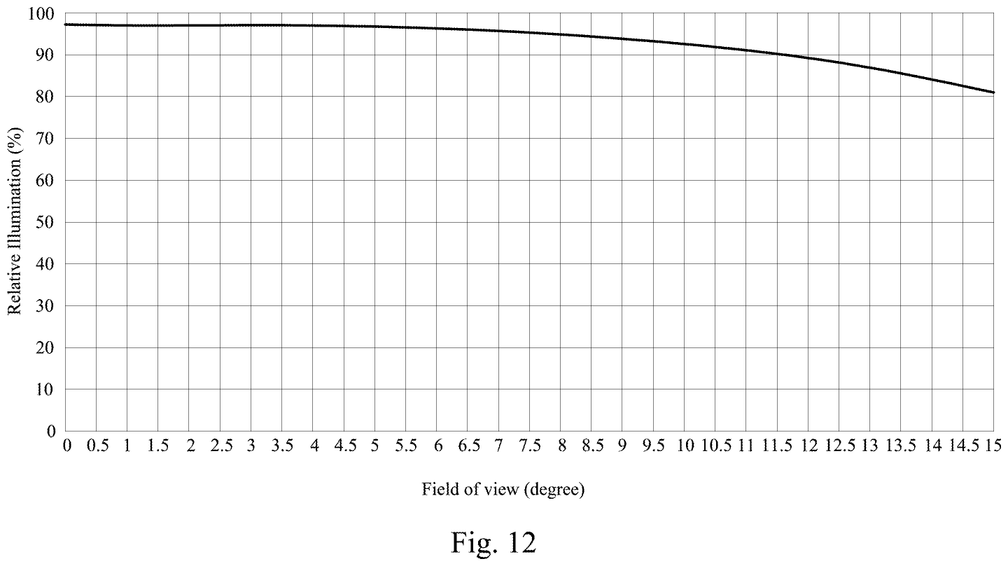

FIG. 12 is a graph of the relative illumination based on the projection lens 100, the polarizing beam splitter 200, and the protection glass 310 in FIG. 3. The relative illumination of the projection lens 100 from the center field to the edge field is substantially greater than 82%, and the relative illumination of the projection lens 100 changes smoothly. Accordingly, the combination of the projection lens 100, the polarizing beam splitter 200, and the protection glass 310 of the present disclosure has great optical quality.

In summary, the f-number of the projection lens of the present disclosure is in a range from 1 to 3. Therefore, the projection lens applied in a projection system having a volume holographic optical element can enhance efficiency of the light entering the volume holographic optical element. The aperture of the projection lens is disposed at the surface of the first lens close to the light emitting side so as to avoid missing of image boundary. The projection lens has a glued first lens group and a glued second lens group to reduce dispersion of the projection lens. The size of the housing of the projection lens 100 is smaller than 30 mm and the total length of the projection lens is in a range from 38 mm to 39 mm, which are beneficial for applications in head-mounted display devices. The material of the lenses of the projection lens can all be glass, and the lenses can all be spherical lens so as to reduce cost. The combination of the projection lens, the polarizing beam splitter 200, and the liquid crystal on silicon panel 300 can improve the third-order aberrations and enhance the Modulation Transfer Function.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A volume holographic optical element projection system, comprising:
a projection lens comprising a light incident side, a light emitting side, and nine lenses, wherein a f-number of the projection lens is in a range from 1 to 3, and the f-number is a value derived from dividing a focal length by an entrance pupil diameter;
a polarizing beam splitter;
a liquid crystal on silicon panel comprising a protection glass, wherein the polarizing beam splitter is located between the light incident side of the projection lens and the protection glass of the liquid crystal on silicon panel; and
a volume holographic optical element, wherein the light emitting side of the projection lens faces the volume holographic optical element.

2. The volume holographic optical element projection system of claim 1, wherein the nine lenses of the projection lens comprises a first lens, the first lens is adjacent to the light emitting side, and the projection lens further comprises:
an aperture proximate to a surface of the first lens facing the light emitting side.

3. The volume holographic optical element projection system of claim 2, wherein a diameter of the aperture is in a range from 13.5 mm to 14.5 mm.

4. The volume holographic optical element projection system of claim 2, wherein a distance between the first lens and the protection glass is in a range from 50 mm to 51 mm.

5. The volume holographic optical element projection system of claim 1, wherein a total length of the projection lens is in a range from 38 mm to 39 mm.

6. The volume holographic optical element projection system of claim 1, wherein a maximum effective diameter of the nine lenses is smaller than or equal to 23 mm.

7. The volume holographic optical element projection system of claim 1, wherein a field of view of the projection lens is greater than 25 degrees and smaller than 35 degrees.

8. The volume holographic optical element projection system of claim 1, wherein the material of each of the nine lenses is glass.

9. The volume holographic optical element projection system of claim 1, wherein each of the nine lenses is a spherical lens.

10. The volume holographic optical element projection system of claim 1, wherein the nine lenses comprises a first lens, a second lens, a third lens, a fourth lens, a fifth lens, a sixth lens, a seventh lens, an eighth lens, and a ninth lens from the light emitting side to the light incident side, wherein the fourth lens and the fifth lens are glued to form a first lens group, and the seventh lens, the eighth lens, and the ninth lens are glued to form a second lens group.

11. A volume holographic optical element projection system, comprising:
a projection lens comprising a light incident side, a light emitting side, and nine lenses, wherein a f-number of the projection lens is in a range from 1 to 3, and the f-number is a value derived from dividing a focal length by an entrance pupil diameter;
an aperture located adjacent to the light emitting side, wherein a diameter of the aperture is substantially equal to the entrance pupil diameter of the projection lens;
a polarizing beam splitter;
a liquid crystal on silicon panel comprising a protection glass, wherein the polarizing beam splitter is located between the light incident side of the projection lens and the protection glass of the liquid crystal on silicon panel; and
a volume holographic optical element, wherein the light emitting side of the projection lens faces the volume holographic optical element.

12. The volume holographic optical element projection system of claim 11, wherein the nine lenses of the projection lens comprises a first lens, the first lens is adjacent to the light emitting side, and the aperture is located at a surface of the first lens facing the light emitting side.

13. The volume holographic optical element projection system of claim 12, wherein a distance between the first lens and the protection glass is in a range from 50 mm to 51 mm.

14. The volume holographic optical element projection system of claim 11, wherein the diameter of the aperture is in a range from 13.5 mm to 14.5 mm.

15. The volume holographic optical element projection system of claim 11, wherein a total length of the projection lens is in a range from 38 mm to 39 mm.

16. The volume holographic optical element projection system of claim 11, wherein a maximum effective diameter of the nine lenses is smaller than or equal to 23 mm.

17. The volume holographic optical element projection system of claim 11, wherein a field of view of the projection lens is greater than 25 degrees and smaller than 35 degrees.

18. The volume holographic optical element projection system of claim 11, wherein the material of each of the nine lenses is glass.

19. The volume holographic optical element projection system of claim 11, wherein each of the nine lenses is a spherical lens.

20. The volume holographic optical element projection system of claim 11, wherein the nine lenses comprises a first lens, a second lens, a third lens, a fourth lens, a fifth lens, a sixth lens, a seventh lens, an eighth lens, and a ninth lens from the light emitting side to the light incident side, wherein the fourth lens and the fifth lens are glued to form a first lens group, and the seventh lens, the eighth lens, and the ninth lens are glued to form a second lens group.
